(19) United States
(12) Patent Application Publication
(10) Pub. No.: US 2021/0116706 A1
(43) Pub. Date: Apr. 22, 2021

(54) COMBINER, HEAD-UP DISPLAY DEVICE, AND METHOD FOR MANUFACTURING COMBINER

(71) Applicant: Konica Minolta, Inc., Tokyo (JP)

(72) Inventors: Yosuke Aoki, Machida-shi, Tokyo (JP); Kazuyuki Nishi, Sakai-shi, Osaka (JP); Masaaki Nose, Kawachinagano-shi, Osaka (JP); Tomonobu Tokunaga, Sakai-shi, Osaka (JP)

(73) Assignee: Konica Minolta, Inc., Tokyo (JP)

(21) Appl. No.: 16/464,371

(22) PCT Filed: Dec. 4, 2017
(86) PCT No.: PCT/JP2017/043406

§ 371 Date: May 28, 2019

(30) Foreign Application Priority Data
Dec. 12, 2016 (JP) 2016-240228

(51) Int. Cl. G02B 27/01

(52) U.S. Cl. CPC G02B 27/0101; G02B 2027/0194

(57) ABSTRACT

A combiner that displays display light from a light source as a display image by reflecting or diffracting the display light in a direction of an observer, the combiner comprising: a base material of a first thermoplastic resin; and an outer layer material of a second thermoplastic resin having a hardness higher than a hardness of the first thermoplastic resin and that covers part of a surface of the base material.

### BACKGROUND

### Technical Field

The present invention relates to a head-up display device which is, for example, primarily used in a car, and more specifically, relates to a head-up display device which allows a driver (observer) to visually confirm scenery ahead of a vehicle which is visually confirmed by light passing through a semi-transparent display member (combiner) and an image and information provided from light reflected at the combiner, which are overlapped in a field of view of the driver, via the combiner, a display member used for the head-up display device, and a method for manufacturing the display member.

### Description of the Related Art

If information such as speed of meters can be directly projected on a windshield, or the like, as a virtual image within a vehicle during driving of a car, a driver can drive without changing his/her field of view, so that it is possible to prevent an accident. Therefore, as means for directly projecting information in a field of view of a person, a head-up display device has been developed. In such a head-up display device, normally, light emitted from a projector such as a small liquid crystal projector passes through and is reflected at a combiner (display member) formed with a transparent base material containing a half mirror material, and the windshield. Therefore, the driver (observer) can acquire information displayed on the combiner, or the like, and acquire external information such as outside scenery through the combiner, or the like, at the same time.

By the way, there is a possibility that, at the combiner, external light such as sunlight is reflected at an upper end face of the combiner and directed to the observer, and the observer may feel dazzled. To address this, Patent Literature 1 discloses diffusing light by making an upper end face of a combiner rougher to prevent light from being reflected in a direction of an observer. Meanwhile, Patent Literature 2 discloses providing a specific fine shape on an upper end face of a combiner to prevent external light from being re-reflected at a windshield of a car and directed to an observer after being reflected at the upper end face. By this means, an amount of light which is re-reflected at the windshield and directed to the observer after being reflected at the upper end face is reduced. Further, to prevent reflection at an end face, there is a case where an R-shape with high accuracy is formed from a side of an upper end face closer to a driver toward a side farther from the driver. Still further, for the purpose other than the purpose of preventing reflection at an end face, there is a case where a fine shape is provided at an end face portion to improve design. Conventionally, a shape of this end face portion is formed using a mold or through cutting work.

### PATENT LITERATURE

Patent Literature 1: Japanese Patent Laid-Open No. 2000-39581
Patent Literature 2: Japanese Patent Laid-Open No. 2014-211533

Here, to provide a certain degree of hardness at a combiner to prevent the combiner from being scratched, there is a case where a hard coating layer is provided at a layer to be formed on a surface of the combiner. While hard coating treatment is typically performed by, after a coating liquid being applied, the coating liquid being cured, at this time, there is a possibility that an end face portion is covered with the coating liquid, and an original shape may be buried. To address this, by creating a fine shape which is large to some extent upon forming, the fine shape can be remained to some extent after the coating liquid is cured, for which a certain effect can be expected. However, due to influence of own weight, or the like, of the coating liquid which acts upon curing, it is difficult to control a shape of coat with high accuracy, and there is a possibility that a shape different from a desired shape may be formed. Further, while the fine shape can be remained to some extent after the coating liquid is cured by making the fine shape larger to some extent, in the case where the fine shape is made finer, there is a possibility that the fine shape may be covered with the coating liquid and buried. Still further, also in the case where an R shape is provided at the end face portion, it is difficult to control the coating liquid to be applied on the R shape at the end face portion, and there is a possibility that a shape after curing may become different from a desired R shape. In such a case, because the buried shape is created again, it requires additional process of cutting work, which leads to an increase in cost.

Therefore, a measure has been developed in which, after a hard coating layer is provided at the combiner, the hard coating layer is removed from an end face of the combiner through cutting work, or the like, to expose a shape of the end face. However, it was found that, if the combiner in which the hard coating layer on the end face is removed is left in a high-temperature environment, a crack is generated in the hard coating layer. One possible cause is a difference in thermal expansion between a base material of the combiner and the hard coating layer. Another possible cause is that, when the hard coating layer on the end face is subjected to cutting work, a notch, or the like, is generated on a worked surface, and a crack is generated originating from this notch, or the like.

### SUMMARY

One or more embodiments of the present invention provide a display member which is less vulnerable, and, at which a defect such as a surface crack is less likely to occur, a head-up display device including the display member, and a method for manufacturing the display member.

A display member of one or more embodiments of the present invention is a display member which displays display light from a light source as a display image by reflecting or diffracting the display light in a direction of an observer to allow the observer to visually confirm the display image, the display member including

a base material formed from a first thermoplastic resin, and

an outer layer material which is formed from a second thermoplastic resin having hardness higher than hardness of the first thermoplastic resin and which covers at least part of a surface of the base material.

A method for manufacturing a display member of one or more embodiments of the present invention is a method for manufacturing a display member which displays display light from a light source as a display image by reflecting or diffracting the display light in a direction of an observer to allow the observer to visually confirm the display image, the method including

forming a base material from a first thermoplastic resin, and

forming an outer layer material which covers at least part of a surface of the base material using a mold by bringing a second thermoplastic resin having hardness higher than hardness of the first thermoplastic resin into contact with the first thermoplastic resin.

According to one or more embodiments of the present invention, it is possible to provide a display member which is less vulnerable, but, at which a defect such as a surface crack is less likely to occur, a head-up display device including the display member, and a method for manufacturing the display member.

### BRIEF DESCRIPTION OF DRAWINGS

FIG. 1 is a diagram illustrating a state where a head-up display device according to one or more embodiments is mounted on a vehicle body VH.

FIG. 2 is a diagram illustrating a configuration of a drawing unit 100 according to one or more embodiments.

FIG. 3A is a diagram illustrating a front side (driver side) of a combiner 200 according to one or more embodiments.

FIG. 3B is a diagram illustrating a configuration in FIG. 3A cut along a line B-B and illustrated in an arrow direction.

FIG. 3C is a diagram illustrating the configuration in FIG. 3A cut along a line C-C and illustrated in an arrow direction.

FIG. 3D is a cross-sectional diagram illustrating an enlarged portion illustrated with an arrow D in FIG. 3B.

FIG. 4 is a cross-sectional diagram illustrating an enlarged part of the combiner 200 according to one or more embodiments.

FIG. 5A is a diagram illustrating manufacturing process of the combiner according to one or more embodiments.

FIG. 5B is a diagram illustrating the manufacturing process of the combiner according to one or more embodiments.

FIG. 5C is a diagram illustrating the manufacturing process of the combiner according to one or more embodiments.

FIG. 5D is a diagram illustrating the manufacturing process of the combiner according to one or more embodiments.

FIG. 6A is a diagram illustrating manufacturing process of a combiner according to one or more embodiments.

FIG. 6B is a diagram illustrating the manufacturing process of the combiner according to one or more embodiments.

FIG. 6C is a diagram illustrating the manufacturing process of the combiner according to one or more embodiments.

FIG. 6D is a diagram illustrating the manufacturing process of the combiner according to one or more embodiments.

FIG. 6E is a diagram illustrating the manufacturing process of the combiner according to one or more embodiments.

FIG. 6F is a diagram illustrating the manufacturing process of the combiner according to one or more embodiments.

FIG. 6G is a diagram illustrating the manufacturing process of the combiner according to one or more embodiments.

FIG. 6H is a diagram illustrating the manufacturing process of the combiner according to one or more embodiments.

### DETAILED DESCRIPTION

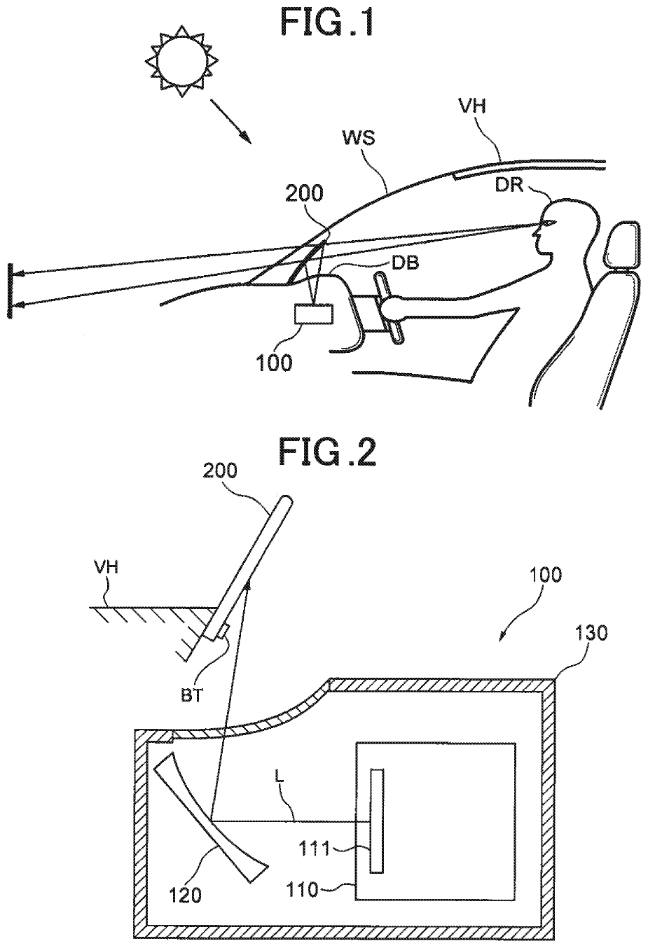

Embodiments of the present invention will be described below on the basis of the drawings. FIG. 1 is a diagram illustrating a state where a head-up display device according to one or more embodiments is mounted on a vehicle body VH. A drawing unit 100 is disposed inside a dashboard DB of the vehicle body VH, and display light is projected on a combiner 200 which is a display member fixedly disposed on the dashboard DB. This display light is led to pupils of a driver DR who is an observer by being reflected or diffracted, and is displayed as a virtual image (display image). Meanwhile, the driver DR can observe a real image such as scenery which passes through a windshield WS and the combiner 200 and which is overlapped on the virtual image. The combiner 200 may be a folding combiner which can be stored inside the dashboard DB. The head-up display device is configured with the drawing unit 100 and the combiner 200.

FIG. 2 is a diagram illustrating a schematic configuration of the drawing unit 100 according to one or more embodiments. The drawing unit 100 is mainly configured with a drawing device 110 including a liquid crystal display panel 111, a concave mirror 120 and a housing 130. Details of a configuration of the drawing device are disclosed in, for example, Japanese Patent Laid-Open No. 2012-203176.

The liquid crystal display panel 111 is formed by polarizing plates being pasted on both front and back surfaces of a liquid crystal cell in which a liquid crystal layer is encapsulated into a pair of translucent substrates on which a transparent electrode film is formed, and a light beam led from a light source which is not illustrated, within the drawing device 110 to a surface of the liquid crystal display panel 111 passes through the liquid crystal display panel 111 and becomes display light L, is radiated on the concave mirror (or flat mirror) 120 which constitutes an optical system for projecting, and is directed to the combiner 200 after being reflected at the concave mirror 120. The combiner 200 is a plate material formed in a plate shape having a thickness between 2 and 3 mm (in one or more embodiments, equal to or less than 10 mm). A projection plane (driver side) of the combiner 200 has a concave toric surface (which may be a free-form surface or a spherical surface) whose radius of curvature is equal to or greater than 100 mm to form a virtual image, and a back side (vehicle front side) has a spherical surface or an aspherical surface similar to the projection plane.

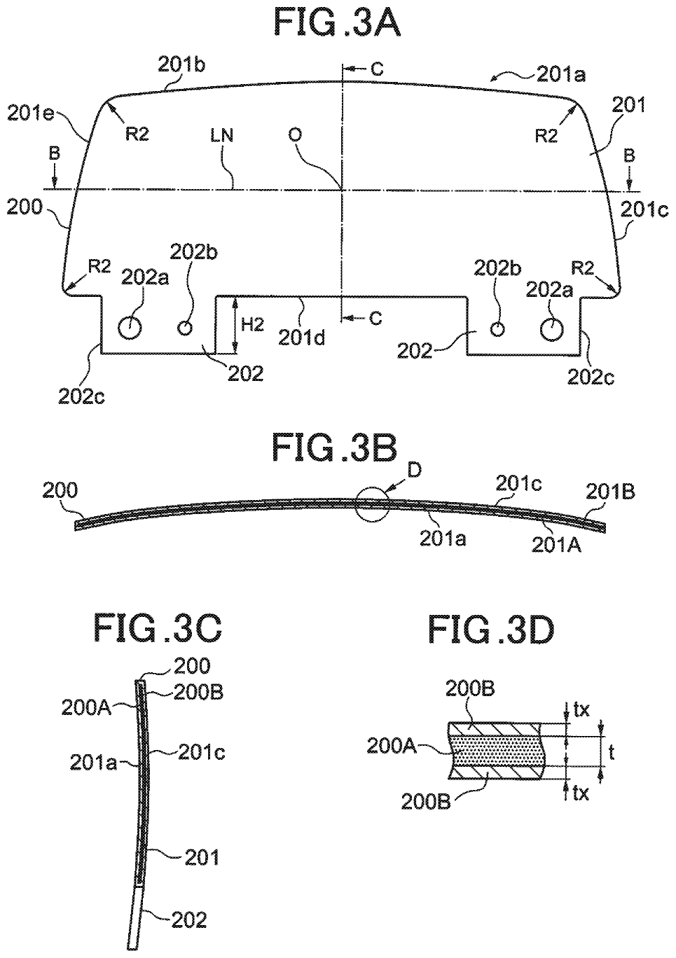

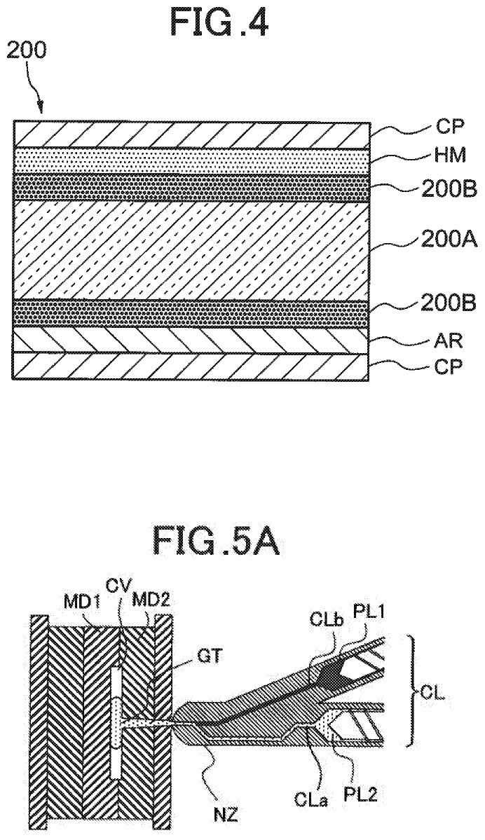

FIG. 3A is a diagram illustrating a front side (driver side) of the combiner 200 according to one or more embodiments, FIG. 3B is a diagram illustrating a configuration in FIG. 3A cut along a line B-B and illustrated in an arrow direction, FIG. 3C is a diagram illustrating the configuration in FIG. 3A cut along a line C-C and illustrated in an arrow direction, and FIG. 3D is a cross-sectional diagram illustrating an enlarged portion illustrated with an arrow D in FIG. 3B. FIG. 4 is a schematic cross-sectional diagram of the combiner 200 on which a function membrane is formed according to one or more embodiments.

In the drawings, the combiner 200 is formed with a base material (core material) 200A formed with a first thermoplastic resin (here, polycarbonate), and an outer layer material 200B formed with a second thermoplastic resin (here, high-hardness polycarbonate) which covers an entire circumference of the base material 200A, using a mold. Hardness of the second thermoplastic resin after curing (which is equal to or higher than HB, and is set at H in pencil hardness in one or more embodiments) is higher than hardness of the first thermoplastic resin (which is equal to or lower than B, and is set at 2B in pencil hardness in one or more embodiments). By optical surfaces (201a, 201c) of the combiner 200 being covered with the second thermoplastic resin which has relatively high hardness, it is possible to suppress scratch, or the like, and eliminate necessity of providing a hard coating layer, or the like. Further, a difference between a refractive index of the first thermoplastic resin and a refractive index of the second thermoplastic resin may be within 0.1, or may be within 0.05 in one or more embodiments. By making the refractive index of the first thermoplastic resin closer to the refractive index of the second thermoplastic resin, it is possible to suppress occurrence of an interference fringe when display light is incident.

Further, a difference between a linear expansion coefficient of the first thermoplastic resin and a linear expansion coefficient of the second thermoplastic resin is within 10⁻⁵ (/° C.) in one or more embodiments, because a defect due to a difference in thermal expansion is less likely to occur when the combiner 200 is held under a high-temperature environment or a low temperature inside a car. Further, as illustrated in FIG. 3D, when a thickness of the base material 200A is set at t (mm) and a thickness of the outer layer material 200B is set at tx, the thickness tx is equal to or greater than 0.01 (mm) and equal to or less than 0.3t (mm) in one or more embodiments. By the thickness tx of the outer layer material 200B being set at equal to or greater than 0.01 (mm), it is possible to effectively exert a scratch prevention function utilizing characteristics of high hardness. Meanwhile, because the second thermoplastic resin is often relatively expensive, by the thickness tx of the outer layer material 200B being set at equal to or less than 0.3t, a usage amount of the second thermoplastic resin is suppressed, so that it is possible to reduce cost. However, the thickness t of the base material 200A is between 1 and 10 (mm) in one or more embodiments. Further, a glass-transition point temperature Tg of the second thermoplastic resin is equal to or lower than 156 (° C.) in one or more embodiments, because the second thermoplastic resin at that temperature can be easily handled.

Further, the combiner 200 is integrally formed with a projection portion 201, and a pair of attaching portions 202. A projection plane (one optical surface) 201a of the projection portion 201 has a concave toric surface (which may be a free-form surface or a spherical surface) whose radius of curvature is equal to or greater than 100 mm to form a virtual image, and a back side (the other optical surface) 201c has a convex spherical surface or an aspherical surface similar to the projection plane 201a. While a sheet thickness of the projection portion 201 is fixed in one or more embodiments, the projection portion 201 may be configured so that a thickness increases or decreases with distance from the center.

As an end face (edge) of the projection portion 201, an upper end face 201b, a side end face 201e, or the like, are formed. Also in the case where a concave and convex shape which suppresses reflection of sunlight is provided at the upper end face 201b and the side end face 201e, by covering the concave and convex shape with the outer layer material 200B having an appropriate thickness, it is possible to preserve the shape with high accuracy, so that it is possible to secure a reflection suppression effect. Further, for example, it is also possible to form the outer layer material 200B having a fine shape on the end face of the base material 200A using a mold, which excels in cost, and which eliminates necessity of machine work, and can thus suppress occurrence of a crack, or the like, due to machine work. However, the outer layer material 200B does not have to be necessarily provided on the end face of the combiner 200.

The projection plane 201a has a spherical surface or an aspherical surface whose radius of curvature is equal to or greater than 100 mm, or may be equal to or greater than 200 mm and equal to or less than 800 mm, and, when a half mirror film is formed as a function membrane, reflectance of light having a wavelength between 420 (nm) and 680 (nm) is set at equal to or higher than 20% in one or more embodiments. Further, when an antireflective film is formed on the projection plane 201a as a function membrane, reflectance of light having a wavelength between 420 (nm) and 680 (nm) is set at equal to or lower than 2% in one or more embodiments. An antifouling coat, or the like, may be provided as the function membrane. The function membrane may be formed with a dielectric body. Such a function membrane can be formed using a method disclosed in, for example, Japanese Patent Laid-Open No. 2004-70301.

As illustrated in FIG. 4, in one or more embodiments, the outer layer material 200B is laminated on both surfaces of the base material 200A of the combiner 200, and, thereafter, a half mirror film HM and an antifouling coat CP are laminated on one surface in this order, and an antireflective film AR and an antifouling coat CP are laminated on the other surface in this order.

The attaching portions 202 leading to a lower end face 201d of the projection portion 201 may have the same rectangular shape and may have an extension surface having the same radius of curvature as that of the projection plane 201a in one or more embodiments. Two attaching holes 202a and 202b are formed at the respective attaching portions 202, and respectively have axial lines parallel to an optical axis. By a bolt BT (see FIG. 2) being inserted into one of the attaching holes 202a and 202b to be threadedly engaged with part of the vehicle body VH or being fixed at part of the vehicle body VH using an adhesive agent, or the like, it is possible to attach the combiner 200 to the vehicle body VH.

### (Sandwich Molding)

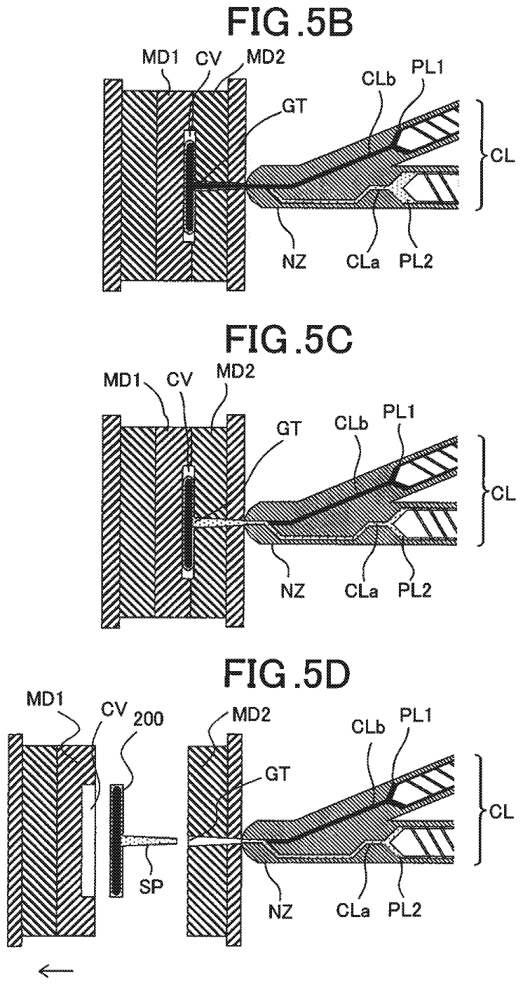

A method for manufacturing the combiner 200 will be described next. First, a method for manufacturing the combiner 200 using sandwich molding will be described with reference to the drawings. FIGS. 5A-5D are diagrams schematically illustrating manufacturing process of the combiner according to one or more embodiments. A cylinder CL to be used in one or more embodiments includes a central opening CLa for injecting the second thermoplastic resin PL2, and a side opening CLb for injecting the first thermoplastic resin PL1, the side opening CLb communicating with the central opening CLa through a nozzle NZ. In the following example, when a thickness of the combiner is set at T (mm), a thickness of the base material is set at 0.6T (mm), and a thickness of each outer layer material is set at 0.3T (mm). By this means, sandwich molding can be easily performed.

In FIG. 5A, the molten second thermoplastic resin PL2 is injected from the central opening CLa of the cylinder CL to inside of a cavity CV of clamped molds MD1 and MD2 via a gate GT. Then, by the first thermoplastic resin PL1 being supplied from the side opening CLb before the second thermoplastic resin PL2 is cured, as illustrated in FIG. 5B, the second thermoplastic rein PL2 forms a skin layer inside the molds MD1 and MD2, the first thermoplastic resin PL1 forms a core layer surrounded by the skin layer, passes through the gate GT and enters the cavity CV.

Thereafter, as illustrated in FIG. 5C, by the second thermoplastic resin PL2 being injected to the gate GT via the central opening CLa, the gate GT is enclosed with the second thermoplastic resin PL2. At this time, it is also possible to form a fine shape at an end portion of the base material with the second thermoplastic resin using a mold. After the thermoplastic resins PL1 and PL2 are cured, as illustrated in FIG. 5D, it is possible to take out the combiner 200 covered with the outer layer material around the base material in a state where a sprue SP is bonded by opening the molds MD1 and MD2. The sprue SP is cut in post-processing.

### (Film Insert Molding)

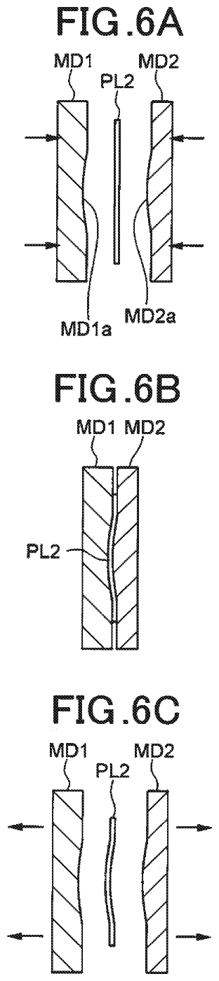

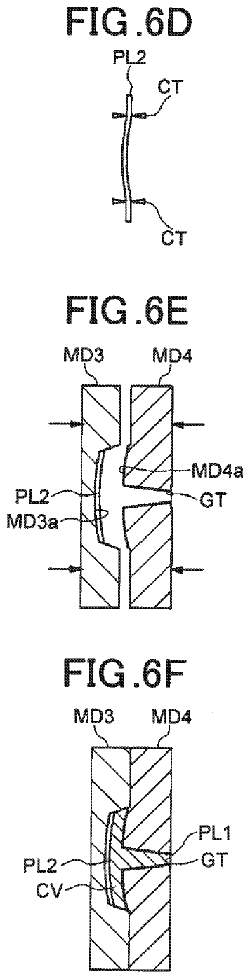

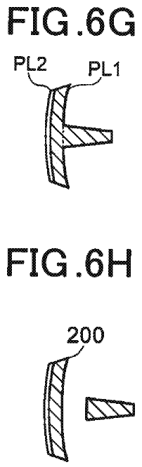

A method for manufacturing the combiner 200 using film insert molding will be described next with reference to the drawings. FIGS. 6A-6H are diagrams schematically illustrating manufacturing process of the combiner according to one or more embodiments. In the following examples, a thickness of the outer layer material is set at 0.2 mm. While the second thermoplastic resin is transferred using a roller, or the like, to form a film-like outer layer material PL2 as preceding process, an adhesive layer is formed in a layer closest to a surface of the film-like outer layer material PL2 in one or more embodiments. As the adhesive layer, an optically clear adhesive is used to secure high transparency in one or more embodiments.

Then, as illustrated in FIG. 6A, a film-like outer layer material PL2 is disposed between the mold MD1 including a concave transfer surface MD1 a having a predetermined radius of curvature, and the MD2 including a convex transfer surface MD2a having a predetermined radius of curvature. Further, the molds MD1 and MD2 are heated at a temperature at which an adhesive layer does not melt, and, by pressing (or vacuum-molding) the film-like outer layer material PL2 from both sides with the transfer surfaces MD1a and MD2a as illustrated in FIG. 6B, a shape of the film-like outer layer material PL2 becomes a curved shape in accordance with the transfer surfaces MD1a and MD2a. Thereafter, as illustrated in FIG. 6C, the film-like outer layer material PL2 is taken out by opening the molds MD1 and MD2.

Further, as illustrated in FIG. 6D, the film-like outer layer material PL2 is trimmed in accordance with the projection plane 201a of the combiner 200 using a cutter CT. The trimmed film-like outer layer material PL2 is disposed between a mold MD3 including a concave transfer surface MD3a having a predetermined radius of curvature and a mold MD4 including a convex transfer surface MD4a having a predetermined radius of curvature as illustrated in FIG. 6E. Still further, a gate GT is formed at the mold MD4. While, the gate GT is disposed within the transfer surface MD4a here to facilitate understanding, it is also possible to employ a side gate type in which a material is allowed to flow into from a direction vertical to a plane of paper.

Further, the molds MD3 and MD4 are clamped as illustrated in FIG. 6F and heated at a temperature at which the adhesive layer of the film-like outer layer material PL2 melts via the gate GT, and the molten first thermoplastic resin PL1 is injected inside the cavity CV with a predetermined pressure. By this means, the film-like outer layer material PL2 is pressed toward the transfer surface MD3a and is tightly in close contact with the transfer surface MD3a. At the same time, the adhesive layer of the film-like outer layer material PL2 melts and is bonded to the injected first thermoplastic resin PL1. This is bonding by a so-called hot melt method. Thereafter, a molded article obtained by the film-like outer layer material PL2 being bonded to the first thermoplastic resin PL1 is taken out after being solidified (FIG. 6G), and a transfer surface is transferred with high accuracy by gate cutting being performed at a position indicated with a dotted line, and thereby the combiner 200 in which part of the base material is covered with the outer layer material is manufactured (FIG. 6H).

As other methods, it is also possible to form the combiner 200 through vacuum pressure forming or in-mold forming. The vacuum pressure forming is performed such that the second thermoplastic resin formed in a film shape is vacuum-bonded to a surface of the first thermoplastic resin formed in advance, and, for example, a three-dimensional surface decorating forming method developed by Fu-se Vacuum Forming Ltd. can be used. The in-mold forming is performed such that only a portion to which heat is applied upon forming, in a film of the second thermoplastic rein which forms a function membrane, is transferred on a base material of the first thermoplastic resin via a release layer.

Results of study performed by the present inventors will be described below. Materials (first thermoplastic resin) of the base material used in the study by the present inventors are PC (polycarbonate), acrylic, COP (cyclo olefin polymer) and COC (cyclo olefin copolymer), and materials (second thermoplastic resin) of the outer layer material are high-hardness PC, acrylic and PET (polyethylene terephthalate), and refractive indexes and pencil hardness of them will be indicated in Table 1. Here, the high-hardness PC is PC having surface pencil hardness from HB to 3H in a solid state at ordinary temperature (injection-molded article, extrusion-molded article), and, for example, product name “lupilon K series” sold by Mitsubishi Engineering-Plastics Corporation can be used.

TABLE 1

| | | |
|---|---|---|
| Material | Refractive index | Hardness |

Base material

| | | |
|---|---|---|
| PC | 1.59 | 2B |
| Acrylic | 1.48 | H |
| COP | 1.531 | HB |
| COC | 1.53 | HB |

Outer layer material

| | | |
|---|---|---|
| High-hardness PC | 1.583 | HB-2H |
| Acrylic | 1.48 | H |
| PET | 1.576 | H |

Note that the refractive indexes were measured in accordance with standards of JIS K7142. Further, the pencil hardness was measured in accordance with standards of JIS K5600-5-.

Compatibility evaluation results of combinations of the base materials and the outer layer materials indicated in Table 1 will be indicated in Table 2. The compatibility evaluation was performed mainly in terms of unlikelihood of occurrence of an interference fringe and affinity between resins. As a result, it was found that combination (a difference in the refractive indexes is 0.007) of PC as the base material and high-hardness PC as the outer layer material is the best, and combination of PC as the base material and acrylic (a difference in the refractive indexes is 0.11) or PET (a difference in the refractive indexes is 0.014) as the outer layer material is the next best.

TABLE 2

| | | Compatibility |
|---|---|---|
| Base material | Outer layer material | evaluation |
| PC | High-hardness PC | ⊙ |
| | Acrylic | ◯ |
| | PET | ◯ |
| Acrylic | High-hardness PC | Δ |
| COP | High-hardness PC | Δ |
| | Acrylic | Δ |
| | PET | Δ |
| COC | High-hardness PC | Δ |
| | Acrylic | Δ |
| | PET | Δ |

The present invention is not limited to the examples described in the specification, and it is obvious for persons skilled in the art that the present invention incorporates other examples and modified examples from the examples and principle described in the present specification. For example, the display member and the head-up display device of one or more embodiments of the present invention can be also used in an airplane and heavy equipment as well as a car.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### INDUSTRIAL APPLICABILITY

The present invention can be utilized for a display member, a head-up display device and a method for manufacturing the display member.

### REFERENCE SIGNS LIST

100 drawing unit
110 drawing device
111 liquid crystal display panel
120 concave mirror
130 housing
200 combiner
200A base material
200B outer layer material
201a projection plane (optical surface)
201b upper end face
201c back side (optical surface)
201d lower end face
201e side end face
202 attaching portion
202a, 202b attaching hole
BT bolt
DB dashboard
DR driver
MD1 to MD4 mold
PL1 first thermoplastic resin
PL2 second thermoplastic resin
VH vehicle body
WS windshield

1. A combiner that displays display light from a light source as a display image by reflecting or diffracting the display light in a direction of an observer, the combiner comprising:
a base material of a first thermoplastic resin; and
an outer layer material of a second thermoplastic resin having a hardness higher than a hardness of the first thermoplastic resin and that covers part of a surface of the base material.

2. The combiner according to claim 1, wherein a difference between a refractive index of the base material and a refractive index of the outer layer material is within 0.1.

3. The combiner according to claim 1, wherein the base material comprises an optical surface that reflects or diffracts the display light, and the outer layer material covers at least the optical surface.

4. The combiner according to claim 1, wherein
the base material has an end face around an optical surface that reflects or diffracts the display light, and
the outer layer material covers the end face.

5. The combiner according to claim 1, wherein
the hardness of the base material is equal to or less than B in pencil hardness, and
the hardness of the outer layer material is equal to or greater than HB in pencil hardness.

6. The combiner according to claim 1, wherein a difference between a linear expansion coefficient of the base material and a linear expansion coefficient of the outer layer material is within 10⁻⁵ (/° C.).

7. The combiner according to claim 1, wherein, a thickness of the outer layer material is equal to or greater than 0.01 (mm) and equal to or less than 0.3t (mm) when a thickness of the base material is set at t (mm).

8. The combiner according to claim 1, wherein a glass-transition point temperature Tg of the outer layer material is equal to or lower than 156 (° C.).

9. The combiner according to claim 1, wherein a function membrane is disposed on a surface of the outer layer material.

10. The combiner according to claim 9, wherein the function membrane is formed with a dielectric body.

11. The combiner according to claim 9, wherein the function membrane is a half mirror film with a reflectance of light having a wavelength between 420 (nm) and 680 (nm) that is equal to or higher than 20%.

12. The combiner according to claim 9, wherein the function membrane is an antireflective film with a reflectance of light having a wavelength between 420 (nm) and 680 (nm) that is equal to or lower than 2%.

13. A head-up display device comprising:
the combiner according to claim 1, and
a drawing unit that emits the display light to the combiner.

14. A method for manufacturing a combiner that displays display light from a light source as a display image by reflecting or diffracting the display light in a direction of an observer, the method comprising:
forming a base material from a first thermoplastic resin; and
forming an outer layer material that covers part of a surface of the base material using a mold by bringing a second thermoplastic resin into contact with the first thermoplastic resin, wherein
the second thermoplastic resin has a hardness higher than a hardness of the first thermoplastic resin.

15. The method for manufacturing the combiner according to claim 14, the method further comprising:
forming a fine shape by forming the outer layer material at an end face of the base material using the mold.
